(19) United States
(12) Patent Application Publication
(10) Pub. No.: US 2012/0260462 A1
(43) Pub. Date: Oct. 18, 2012

(54) PALLET FOOT, A PALLET AND A BOX PROVIDED WITH FEET AND ALSO A METHOD FOR ATTACHING A PALLET FOOT TO A PLATFORM

(75) Inventor: Birger Nielsen, Sparsor (SE)

(73) Assignee: Sparsors Plast KB, Sparsor (SE)

(21) Appl. No.: 13/500,309

(22) PCT Filed: Oct. 13, 2010
(86) PCT No.: PCT/SE10/51101

§ 371 Date: Jul. 3, 2012

(30) Foreign Application Priority Data
Oct. 13, 2009 (SE) 0950753-4
Mar. 29, 2010 (SE) 1050294-6

(51) Int. Cl. B65D 19/40; B23P 11/00

(52) U.S. Cl. 16/42 R; 29/432

(57) ABSTRACT

The following invention relates to a pallet foot of overall hollow shape for being fixed on the back of a platform, where the base of the pallet foot has a horizontal flanged edge for meeting the surface of the back of the platform wherein said horizontal flanged edge comprises a plurality of substantially vertically protruding attachment members for penetrating said platform. The application also includes a pallet and a box provide with feet and also a method for attaching a pallet foot to a platform.

### TECHNICAL FIELD

The present invention relates to a pallet foot of overall hollow and tapered shape for being fixed on the back of a platform, where the widest open base of the pallet foot has a horizontal flanged edge for meeting the surface of the back of said platform. Further, the present invention relates to a method for fixating a pallet foot onto a platform.

### BACKGROUND ART

Pallets of various kinds are commonly used within transporting as well as for storing of goods. As they are frequently made out of wooden material, pallets are both relatively expensive to manufacture, and heavy. Their considerable weight means they are hard to handle and may cause back-injuries to a user upon lifting or moving it. Another disadvantage coming with a wooden pallet is that the fork of a fork lift truck can enter the pallet from one direction only. Also, during transports pallets represent a large proportion of the total weight resulting in undesirable high fuel consumptions. For these and other reasons it has previously been suggested to replace traditional pallets with goods-handling pallets of lighter materials. In U.S. Pat. No. 5,154,297 is shown a plastic foot assembly which may be attached to a box in order to simulate a pallet. Further, US2005/0229819 shows plastic deck support structures with prongs arranged to engage the lower surface of a deck so that the support structure is attached thereto. Another example of a plastic pallet foot is proposed in GB2126560 where hollow body is designed to be fixed on the back of a platform where the platform may be a sheet of cardboard or a paper box. The aforementioned pallet support structures are made out of plastic which is undesirable from an environmental point of view. The pallet feet of both U.S. Pat. No. 5,154,297 and GB2126560 are meant to be attached onto the cardboard by means of gluing with an adhesive that is prepared on the pallet foot. If gluing is done in dirty or dusty environment it may occur that such dirt or dust gets in between the adhesive surface and the cardboard leading to insufficient fixation. In damp, wet or hot environments it might also occur that the adhesive comes loose of the cardboard and the pallet foot detaches.

In view of the foregoing, improved pallet feet are desirable.

### OBJECTS OF THE INVENTION

It is a primary object of the present invention to provide an improved pallet foot and a simplified and effective method for fixating the same onto the back of a platform.

Further objects of the invention is to provide a pallet foot that:
is easily, quickly and permanently fixated to a platform
will stay fixed during damp, wet and/or high/low temperatures
is recyclable
is environmentally friendly
is inexpensive to manufacture and/or purchase
suits a wide variety of different size platforms, which platform preferably is in the form of cardboards or boxes
will aid in constituting a pallet which may be entered by the forks of a fork lift truck from any side of the pallet
will aid in constituting a lightweight pallet

Additional objects of the invention will become evident from the following description and the claims.

### DISCLOSURE OF THE INVENTION

The objects of the invention are accomplished by a pallet foot arranged to be attached onto a penetrable platform, where the pallet foot has an overall hollow shape and comprises an upper base portion with a stopping surface arranged to meet the surface of said platform, and wherein said base portion comprises a plurality of attachment members for penetrating the platform.

It is understood that by “penetrable” means a material which can be penetrated by the attachment members, for instance cellulose- or paper based materials such as cardboard, paperboard or corrugated fiberboard. It is further understood that a platform may refer to for instance a sheet of paper or the bottom of a paper box.

According to one aspect of the invention the attachment members are extending in a direction substantially perpendicular to said stopping surface. According to one embodiment if the invention the stopping surface is a horizontal flanged edge arranged to meet the surface of the back of the platform. The horizontal flanged edge is surrounding an opening at the upper base portion of the pallet foot, and comprises a plurality of vertically protruding attachment members for penetrating said platform.

Thanks to the protruding attachment members the pallet foot may be attached onto a platform in an instant, without the risk of having dust, dirt or surrounding circumstances like humidity or temperature deteriorate the fixating ability of the foot. The attachment members safeguard that the pallet foot is fixated to the platform in a mechanically stable way and prevent it from detaching due to wet or warm surroundings. In a preferred form the pallet foot has a tapered and overall hollow shape, and is open at the upper portion (i.e. the portion which is intended to meet a platform). Preferably the pallet foot has a shape of a truncated pyramid, and said opening has a substantially tetragonal cross-section. Thanks to the hollow shape a plurality of pallet feet may be stacked together which enables efficient storing.

Preferably, the pallet foot according to the invention is made out of a cardboard material, but it is also possible to manufacture it from plastic material such as polypropylene. Preferably, the platform to be penetrated is in the form of a cardboard sheet or a paper box, meaning if the pallet foot is made in paper based material the entire pallet will be made out of the same material, and the assembly may be recycled as one entity which provides simplicity in the recycling procedure as well as it is eco-friendly.

A pallet made out of paper material, alternatively out of paper and plastic material, will provide a lightweight construction suitable for substantially reduced loading weights. The pallet foot according to the invention may be instantly attached to any kind of penetrable platform which makes it universal and user-friendly. Thanks to the invention is provided a simple way of constructing a pallet very quickly and inexpensively. A pallet that is constructed by having attached a number of pallet feet to the back can also be entered by the forks of a fork lift truck from any side.

According to another aspect of the invention the lower portion of the pallet foot (i.e. the portion which is opposite to the upper portion) comprises at least one, preferably two, through grooves at the respective sides of the pyramidal pallet foot. Said through grooves are arranged to match stabilizing beam members onto which pallet feet may be positioned. Preferably each through groove is substantially wedge shaped so that a matching beam is readily fastened upon placing the pallet feet thereupon. Obviously said through grooves may comprise any other suitable shape or design, such as having a snap-in function allowing for a pallet foot to be attached to a beam member or underlying structure.

### BRIEF DESCRIPTION OF THE DRAWINGS

The invention will hereinafter be described in more detail with reference to the accompanying drawings. The following descriptions should be considered as preferred forms only, and are not decisive in a limiting sense.

FIG. 1: is a perspective view showing a pallet foot according to one embodiment of the invention,

FIG. 2: is another perspective view showing the pallet foot seen in FIG. 1 and FIG. 2,

FIG. 3: is a side view of a pallet foot shown in FIG. 1 and FIG. 2,

FIG. 4: is a top planar view of a pallet foot,

FIG. 5: is a perspective view of a pallet foot being stabilized by an underlying beam element,

FIGS. 6a-c: show examples of different attachment members according to the present invention,

FIG. 6d illustrates in an exemplified way attachment members according one embodiment of the invention penetrating the surface of a platform,

FIGS. 7a-b: show pallet feet attached to the underside of a platform thus forming a pallet,

FIG. 8a: is a perspective view of a pallet foot according to another embodiment of the invention,

FIG. 8b: is a perspective view of a pallet foot according FIG. 8a, seen from below,

FIG. 9: is a support device according to the invention,

FIG. 10a: is another support device according to the invention, and

FIG. 10b: is a detailed view according to Xb in FIG. 10a.

### DETAILED DESCRIPTION OF THE INVENTION

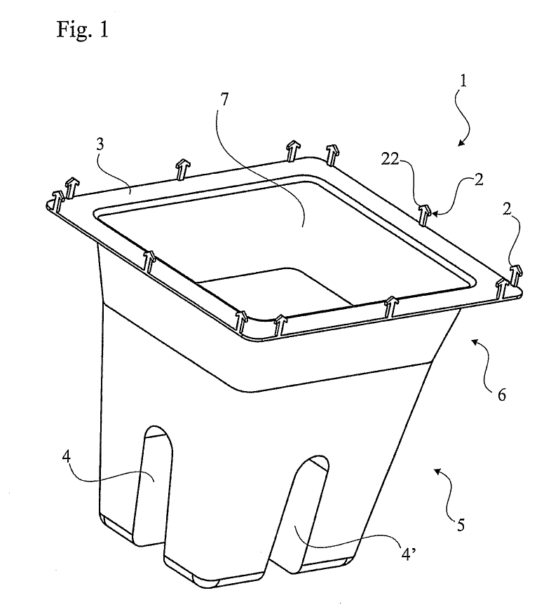

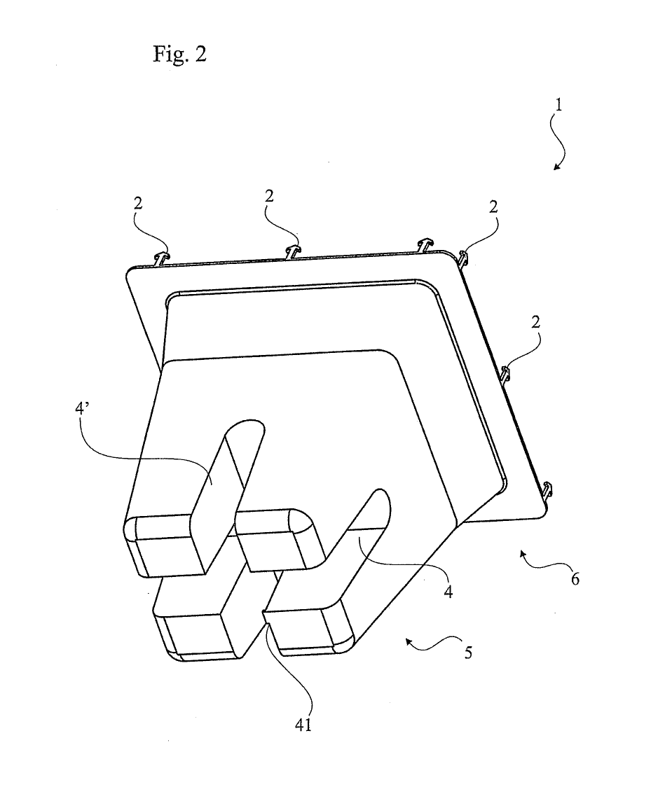

FIGS. 1-4 show a pallet foot 1 according to a preferred embodiment of the present invention, having an overall tapered and hollow shape. The wider upper base 6 of the pallet foot 1 presents an opening 7 surrounded by a stopping surface in the form of a horizontal flanged edge 3 for meeting the surface of an underside 81 of a platform 8 (see FIGS. 7a-b), where a platform for instance might be in the form of a cardboard sheet or other penetrable, rigid paper material suitable for constituting the platform of a pallet.

It is understood that the terms “horizontally” and “vertically” is to be put in relation to a platform 8 onto which a pallet foot 1 is to be attached. Horizontal then refers to the plane which is defined by such a platform 8, and vertical refers to a direction perpendicular to the plane which is defined by the platform 8.

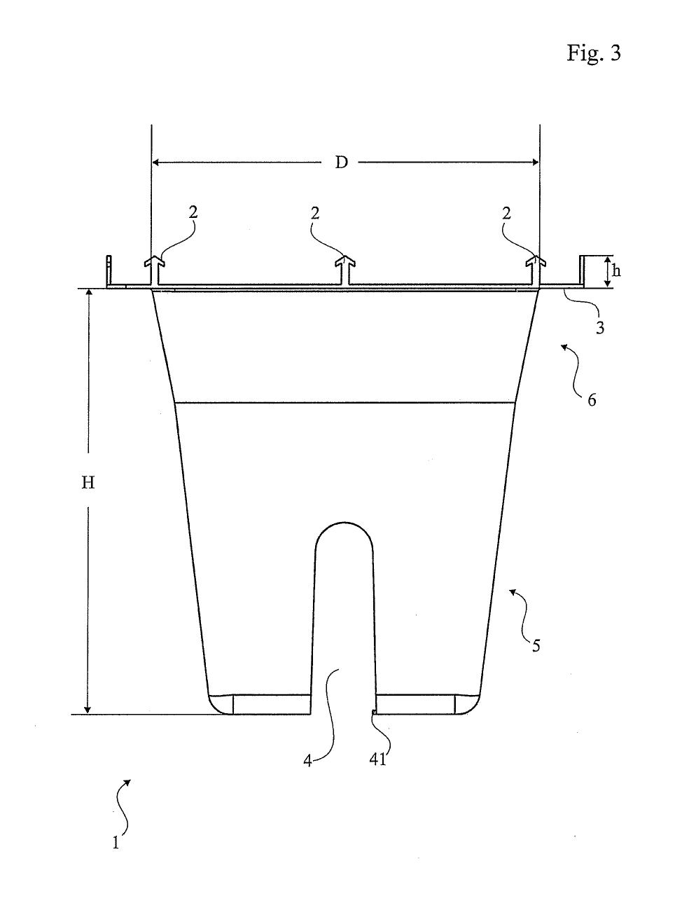

The horizontal flanged edge 3 comprises a plurality of substantially vertically protruding attachment members 2 for penetrating said platform 8. Preferably said attachment members 2 are distributed evenly around the circumference of said edge 3, so that each one of the four sides of the pallet foot 1 according to FIG. 1 comprises at least one, preferably at least two vertical attachment members 2 with height h (see FIG. 3). In the example of FIG. 1 each side of the pallet foot 1 comprises three protruding attachment members 2, which will ensure a reliable attachment onto e.g. a paperboard sheet. It is obvious that the attachment members 2 may be distributed in many different ways around said opening 7 of the foot 1. In the example of FIG. 1 the attachment members 2 are arrow-like and comprises barb elements 22 which are arranged to permanently retain a pallet foot 1 onto a platform 8 once attached thereto. Many different orientations of said attachment members 2, and thus the direction of said barb members 22, are possible. In FIGS. 1-5 all attachment members are arranged with barb elements 22 aligned with the respective side of the pallet foot 1, however it is possible to position the attachment members 2 so that the barb elements 22 are directed for instance perpendicularly against the respective side of the pallet foot 1. By providing a pallet foot 1 where the attachment members 2 are arranged with different orientations (e.g. barb elements 22 pointing towards different directions) the retaining elements 22 of the plurality of attachment members 2 of a foot 1 will result in counteracting locking engagement, and that the differently oriented retaining elements 22 thus cooperate with each other for permanently locking the attachment members 2 against the surface 81 of the platform 8 being penetrated. Such possibilities may be also advantageous for instance when the platform 8 to be penetrated comprises an uneven structure in which case a certain alignment of the attachment members may prove to be more beneficial in order to attain a mechanically stable and permanent attachment of a pallet foot 1.

It is understood that the term “permanently” is used for illustrating that the attachment members 2 of a pallet foot 1 are intended to prevent the pallet foot 1 from detaching from a platform 8 once attached thereto, implying that each pallet foot 1 is preferably intended for single-use. If for instance said attachment members 2 are broken the pallet foot 1 may obviously become separated from a platform 8, but that this would lead to that the pallet foot 1 might not be used further.

A pallet foot 1 according to the present invention is to be fixated onto a platform 8 in the following way. A penetrable platform 8, preferably a pre-cut sheet of cardboard, and at least four pallet feet 1 are provided, one pallet foot for each corner of the platform 8. An operator directs a pallet foot 1 so that the wider upper base 6 faces the underside 81 of the platform 8 and the horizontal flanged edge 3 meets the undersurface of said platform. Preferably the underside 81 (see FIGS. 7a-b) of the platform 8 is provided with pre-marked areas for guidance of where to attach a foot 1. For attachment the operator next forces the vertically protruding members 2 towards the platform so that the protruding attachment members 2 punctuates the platform surface 81 and penetrate the platform 8 and thereby become affixed thereto. As the attachment members 2 penetrate the platform the stopping surface 3 (i.e. the horizontal flanged edge 3) will approach the platform 8 and eventually meet the surface 81 thus stopping further penetration. Preferably penetration is stopped at the point when the entire height h of the attachment members 2 has penetrated the platform. This way every pallet foot 1 will penetrate a platform 8 equally much, and a pallet with a plurality of attached pallet feet 1 according to the invention becomes symmetric and stable since all feet 1 will protrude from the platform to the same extent.

In a preferred method according to the invention, the operator will cause penetration of said attachment members 2 by pressing or hitting the foot 1 against the underside 81 of the platform when said foot 1 is rightfully positioned and said stopping surface 3 is arranged to meet the surface 81 of the platform 8. Hitting the foot 1 against the platform 8 will lead to that the preferably pointy attachment members 2 are instantly forced into and through the platform 8, penetrating it, thus fixating the pallet foot 1. This way a number of feet 1 are attached onto the underside 81 of a platform or a sheet providing an easy and instant way of forming a pallet.

It is to be understood that by penetrate means “to at least partially pass through the thickness” of the cardboard. Preferably the attachment members 2 are designed so that their total height h corresponds at least to the thickness t of the platform 8 which is about to be penetrated, however attachment will work also if the total height h is less than or larger than said thickness t. Preferably the cardboard sheet is pre-cut to a squared shape, adapted in size for use in logistics and storing, but it is of course possible to fixate a pallet foot 1 according to the invention onto any type of sheet, having any contour, or onto the bottom side of a paper box.

The pallet foot 1 according to the example shown in FIGS. 1-4 has the shape of a of a truncated pyramid, and a substantially tetragonal cross-section, however, other shapes are equally possible. For instance the pallet foot may have the form of a truncated cone, or of a cylinder, or it may have a circular, triangular or any polygonal cross section.

Preferably a pallet foot 1 is made out of paper material, for instance manufactured by means of press-shaping. It is, however, possible to produce the pallet foot out of injected plastic material such as polypropylene, in which case the pallet foot body may be molded into a desired shape, in a preferred form in a shape corresponding to the appended drawings.

In FIG. 3 is seen a side view of a pallet foot 1 according to a preferred embodiment of the invention. By way of example, a foot 1 such as illustrated in FIGS. 1-5 is given the following dimensions. The pallet foot 1 preferably has a height H between 50-150 mm more preferred between 75-110 mm, even more preferred between 80-100 mm.

Further the pallet foot 1 preferably has a width D in the range between 90-160 mm, more preferred between 110-140 mm, even more preferred between 120-130 mm. The attachment members 2 are protruding substantially vertically from the stopping surface 3 with a height h.

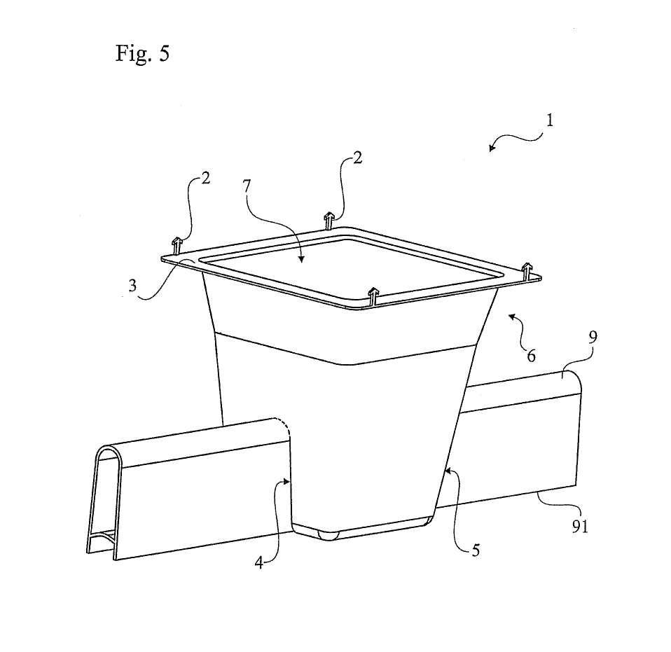

The foot 1 comprises a through groove 4 at the small base portion 5 of the foot 1. According to one example of the invention the groove 4 is substantially U-shaped and comprises a stopping member 41 at one end. As will be described in more detail in connection to FIG. 5, the groove 4 is arranged to match an underlying structure, such as a beam element 9 which can be introduced into groove 4 for stabilization. Said stopping member 41 will grip an introduced beam element 9 retaining it within the groove 4.

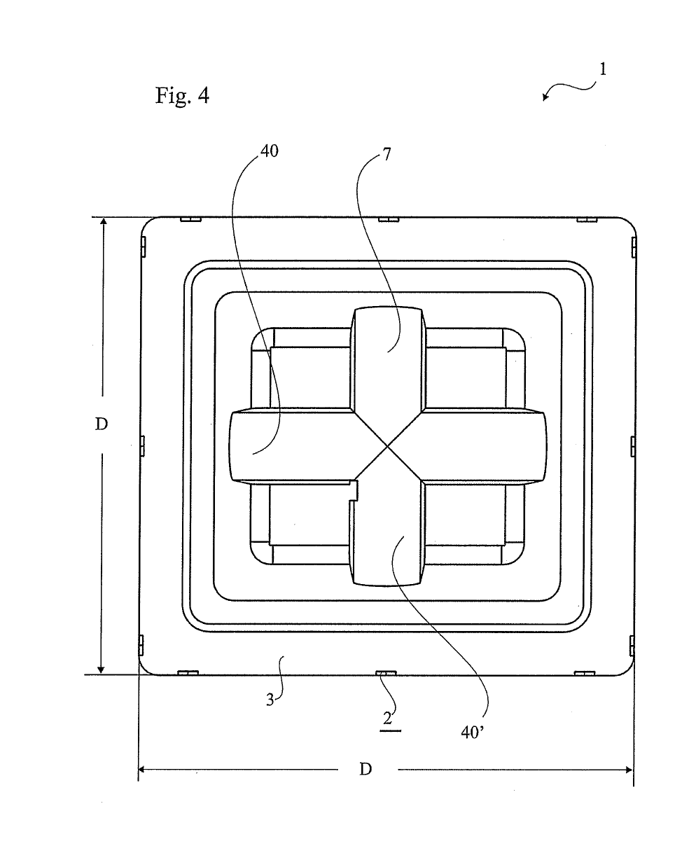

Referring now to FIG. 4, the pallet foot 1 according to one example comprises a tetragonal cross-section where preferably each side has the same length D, said opening 7 thus being square shaped. FIG. 4 shows a planar view of the pallet foot 1 seen from above, said horizontally extending edge 3 surrounding the opening 7 of the upper wider part 6. Here is also seen the inner structures 40, 40′ forming grooves 4, 4′ of the pallet foot 1, protruding upwards into the hollow portion of the foot 1.

FIG. 5 is a perspective view of a pallet foot 1 being stabilized by an underlying beam element 9, which beam element 9 is positioned through a groove 4 in the lower narrowest portion 5 the pallet foot 1. The pallet foot 1 seen in FIG. 5 comprises only one through groove 4, however a pallet foot 1 may comprise two through grooves 4, 4′ as seen in FIGS. 1-4: one on each side of the foot 1. The grooves 4, 4′ can be used for stabilizing a pallet (comprising a number of pallet feet 1) onto an underlying matching structure or protrusion, for instance an underlying beam 9. According to the example of FIG. 5 the though groove 4 is U-shaped with an internally tapered surface arranged to cooperate with the generally tapered exterior surface of a wedge-shaped beam element 9. When beam element 9 is fully engaged in the receiving groove 4 it is tightly retained by the tapered inner surface of said groove 4 and by the stopping member 41 previously described in connection to FIG. 3. Preferably the stopping member 41 is positioned so that when beam element 9 is completely introduced into a groove 4 it will grip around the lower edge 91 of the beam 9 thereby safeguard retention of the beam 9.

A person skilled in the art realizes that the grooves 4, 4′ may have various dimensions, all depending on the purpose of use. For instance, if the pallet feet 1 of a pallet comprise two perpendicular through grooves 4, 4′ (see FIGS. 1-4) the pallet may be supported by an underlying structure in the form of a grid of beam elements 9 onto which the pallet feet 1 are positioned. The shape of the groove 4, 4′ is however preferably matched by the profile of an underlying beam or bar element 9 for attaining the stabilizing function as previously described. In addition to a wedge-shaped beam element 9 matching a tapered groove 4, 4′ it would be possible to provide the groove and the respective beam with a snap-in function for interconnection.

Further, the grooves could be adjusted to match the dimensions of the sides of a pallet collar so that a platform with pallet feet 1 may be stacked thereupon, e.g. with grooves 4, 4′ placed so that they surround the walls of an underlying pallet collar. It is also understood that the lower portion 5 of the pallet collar 1 may be designed to match any underlying object, such as a conventional pallet, various models of pallet collars or the like, without departing from the scope of the claims.

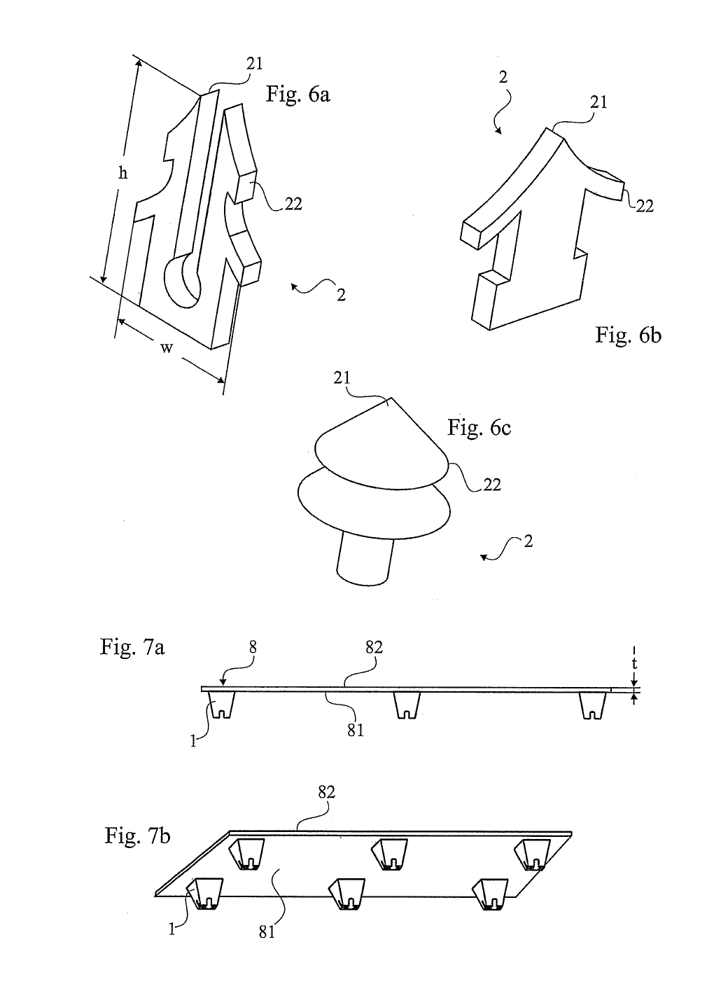

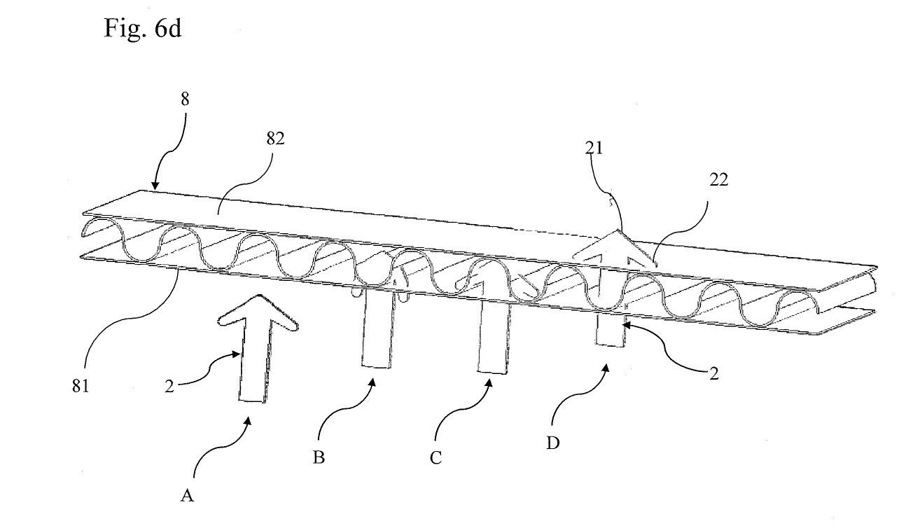

FIG. 6 shows three examples of attachment members 2, each of which presents a pointy upper part 21 for facilitating penetration through e.g. a cardboard material. The height h of an attachment member 2 can be adapted to the thickness of the material to be penetrated. For instance a standard thickness t of cardboard is 7 mm, in which case the height h of an attachment member would be around 7-8 mm. Preferably the height h of an attachment member is between 5-15 mm, more preferred 7-10 mm. Preferably the width w of an attachment member 2 is between 4-12 mm, more preferred between 5-7 mm.

Indeed, an attachment member 2 may be designed with a height h larger than the thickness t of the cardboard 8 to be penetrated, which would lead to that a portion 21 of the attachment members 2 will protrude through the upper side 82 of the platform when affixed thereto. The protruding attachment members 2 may thus interact with and stabilize objects, for instance paper boxes, placed and stored upon the platform of a pallet, and prevent stored objects from undesirable moving or sliding.

Preferably an attachment member 2 is provided with at least one retaining means, for instance in the form of barb elements 22, which ensure that the attachment member 2, once having penetrated a platform sheet 8, will stick thereto and not come loose from its surface.

Looking now at FIG. 6d, there is illustrated in a schematic way the penetration of an attachment member 2 according to one embodiment of the invention through a penetrable cardboard platform 8, here shown as a corrugated fiberboard. Said penetration is illustrated as a sequence showing four subsequent positions A, B, C, D of said attachment member 2 as it pierces through the corrugated fiberboard 8.

An initial position A is shown where an attachment member 2 comprising a pair of retaining means 22 is in a neutral disposition and approaches the undersurface 81 of the fiberboard 8. In a subsequent position B the attachment member 2 is shown after having punctuated the lower surface 81 of the fiberboard, partially having penetrated through the cardboard 8 thickness. In this position B only the pointy top portion 21 of the attachment member 2 has pierced through the undersurface 81, while the barb elements 22 still extends out from the undersurface 81. As is seen in position B the barb elements 22 are arranged to partially flex (slightly bend) as the attachment member 2 penetrates the cardboard 8, leading to that penetration is facilitated. The third position C shown herein illustrates an attachment member 2 which has advanced through the paperboard thickness to such an extent that the entire tip portion 21 and the barb elements 22 are enclosed within the fiberboard 8 interior. In this position C the barb elements 22 have flexed back to a neutral unfolded outline and will thereby prevent the attachment member 2 from rearward movement and detach from the cardboard 8. The final position D shown in the given example of FIG. 6d shows how the attachment member 2 has penetrated also the upper surface 82 of the corrugated fiberboard 8 so that the tip portion 21 protrudes upwards from the upper surface 82. The retaining means 22 are in a neutral unfolded position and the pointy part of the barb elements 22 are projecting backwards from the tip 21 of the attachment member 2 keeping it from detaching from the cardboard 8. The described design of the attachment members 2 according to the invention will lead to that a pallet foot 1 once attached onto a platform 8 will be permanently affixed thereto and lead to mechanically stable retainment with minimal risk of detachment.

In FIGS. 7a-b are seen a number of pallet feet 1 attached to a platform 8, here a sheet of square-shaped cardboard 8 having an underside 81 and an upper side 82. A plurality of six feet 1 have been attached onto the underside 81 of said cardboard sheet 8 to form a pallet. If needed, more pallet feet may be added in order to strengthen the structure and rigidity of the pallet. Evidently it is also possible to affix the feet onto the bottom side of a paper box.

As is seen herein, a pallet of the shown kind can be entered by the forks of a fork lift truck from any side.

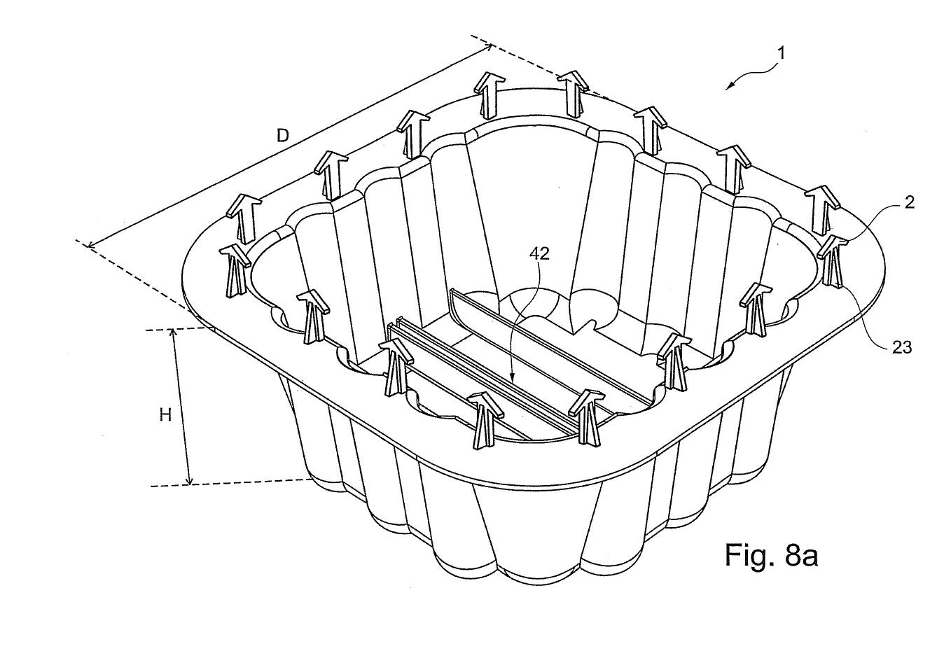

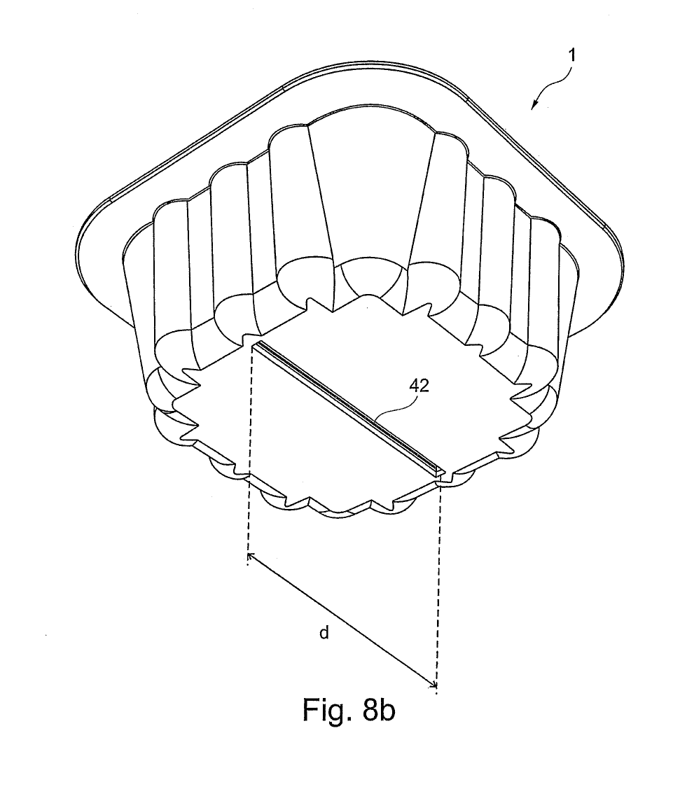

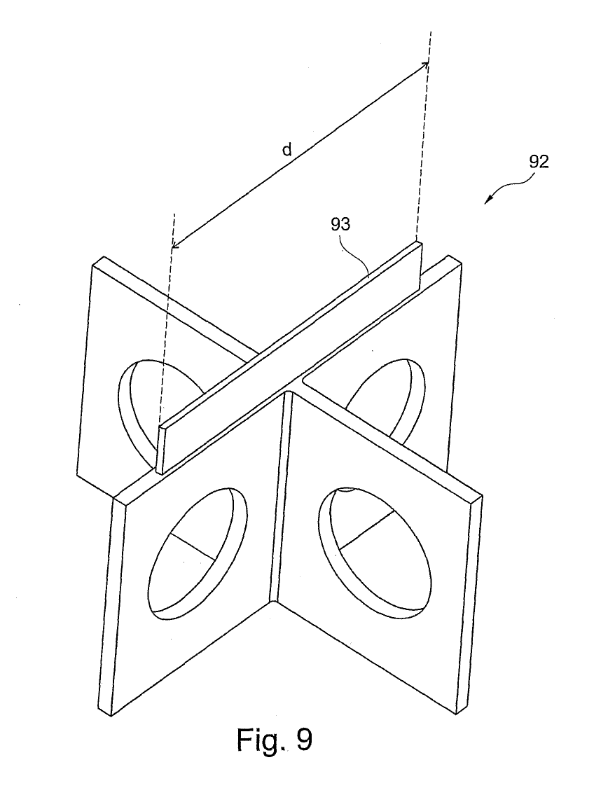

FIG. 8a shows another embodiment according to the invention, wherein a pallet foot 1 comprises a compact design. The compactness of the pallet foot 1 mainly resides in the height H being short in relation to the width D compared to the embodiment shown in FIGS. 1-7. A compact, low pallet foot 1 may be advantageous for instance during transportation and storing since it leads to space savings. The pallet foot 1 in FIG. 8a comprises a plurality of four attachment members 2 per side, where each attachment member further is provided with a stabilizing structure 23 for safeguarding that the attachment members 2 do not break during fastening onto a platform 8.

The compact pallet foot 1 is shown from below in FIG. 8b, wherein it is seen to comprise a slot 42 arranged across the underside. The slot 42 may open towards the inside of the pallet foot 1 or it may be blind. The purpose of the slot 42 is to provide a location for a supporting component, for instance in the form of a support device 92 according to the one shown in FIG. 9. The support device 92 comprises a protruding ridge portion 93 arranged to fit into the slot 42 of the pallet foot 1. Fitting of a support device 93 will lead to that the compact pallet foot 1 is elevated to an extent corresponding to the height of the support device 93. Hereby the otherwise very low pallet foot 1 may be elevated, for instance in case it is desired to make it compatible with various types of forklift trucks. The smaller pallet-moving tool (pallet jack) comprises dimensions for lifting a pallet with very low feet, however a larger sized forklift may not be able to fit the fork under a low pallet. For this reason it is advantageous being able to vary the height of the foot 1 in order to adapt its dimensions to various situations, i.e. keeping a low pallet during cargo transportation and elevate it for moving with a forklift.

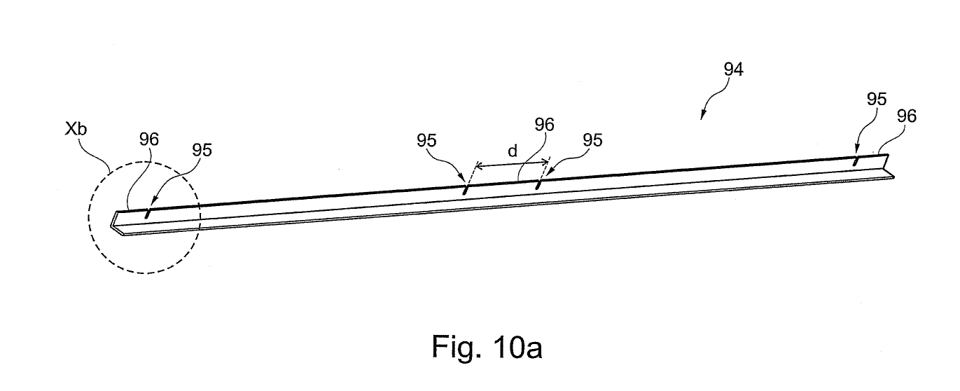

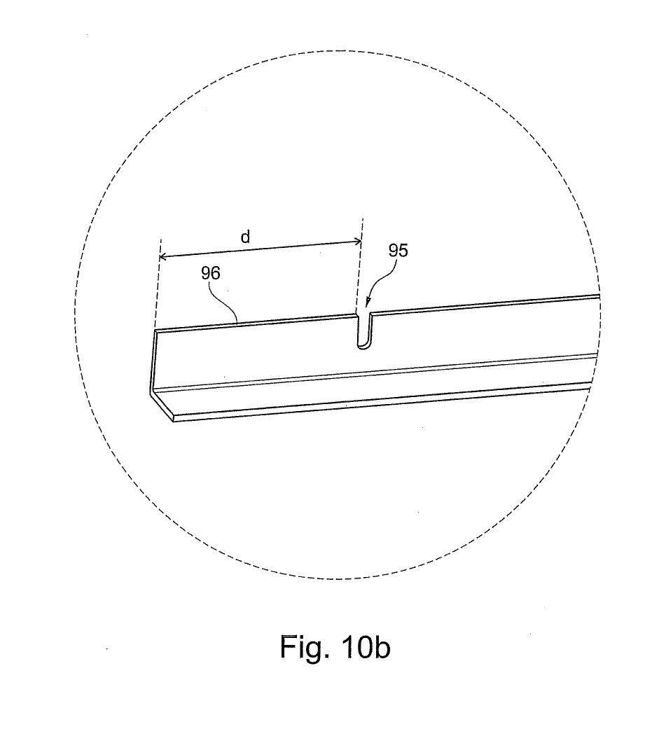

FIGS. 10a-b show yet another example of a support structure 94 according to the invention, here in the shape of a support strip 94 comprising an L-shaped cross section. Preferably the support strip 94 is made out of hard plastic material, however any suitable material may be used. As seen in the encircled enlargement in FIG. 10b the strip comprises a number of grooves 95. The grooves divide the strip into sections whereof three sections 96 are arranged to fit into corresponding slot 42 of a compact pallet foot 1. Preferably the portion of the support strip 94 which is arranged to fit into the slot 42 has the same length d as the length d of the slot opening.

The function of the support strip 94 will now be described. A pallet platform 8 is provided with a number of pallet feet 1 each foot comprising a slot 42. In the following example the platform is provided with a total number of six feet arranged as shown in FIG. 7b. Moreover adjacent feet 1 are arranged so that their respective slots 42 are aligned with each other, e.g. so that the three feet 1 along the longer side of the pallet are aligned with respect to their slots 42. In order provide an extra support and stability to the pallet it may be positioned onto the support structure 94 in such a way that sections 96 of the strip 94 are fitted into the slots 42 of aligned pallet feet 1. Thanks to the grooves said slots 42 will cooperate with the support strip 94 in such a way that a pallet foot is unable to slide sideways, and will be kept in position on the support structure 94. Evidently additional designs of a support structure is conceivable, for instance instead of a linear slot 42 a pallet foot 1 may have a cross-shaped cutting on its underside leading to the possibility of a support structure in the shape of a grid onto which pallets may be fitted and stabilized. Also one support strip 94 may support the pallet feet of adjacent pallets so that they are stabilized in relation to each other.

It is understood that the objects of the present invention set forth above, among those made apparent by the detailed description, shall be interpreted as illustrative and not in a limiting sense. Within the scope of the following claims the set-up of various alterations of the present invention may be possible, for instance a different design of the grooves 4, 4′ and/or the underlying beam element 9.

1-19. (canceled)

20. A pallet foot arranged to be attached onto a penetrable platform, where the pallet foot has an overall hollow shape and comprises an upper base portion having a stopping surface arranged to meet the surface of said platform, said upper base portion further comprising a plurality of attachment members, wherein said plurality of attachment members are arranged to pierce through the undersurface of said platform, and that said plurality of attachment members further are arranged to at least partially penetrate the thickness of said platform and to permanently retain said pallet foot on the platform once the pallet foot is attached thereto.

21. The pallet foot according to claim 20, wherein said attachment members are extending in a direction substantially perpendicular to said stopping surface.

22. The pallet foot according to claim 20, wherein said stopping surface is a horizontal flanged edge surrounding an opening at the upper base portion of the pallet foot.

23. The pallet foot according to claim 20, wherein said pallet foot comprises an overall tapered shape.

24. The pallet foot according to claim 20, wherein said pallet foot is made out of cardboard.

25. The pallet foot according to claim 20, wherein said pallet foot is made out of a plastic material.

26. The pallet foot according to claim 20, wherein said pallet foot has a shape of a truncated pyramid, and said opening has a substantially tetragonal cross-section.

27. The pallet foot according to claim 26, wherein each side of the upper base portion of said pallet foot comprises at least two attachment members.

28. The pallet foot according to claim 26, wherein each side of the upper base portion of said pallet foot comprises more than two attachment members.

29. The pallet foot according to claim 20, wherein the lower portion of the pallet foot comprises at least one through grooves.

30. The pallet foot according to claim 20, wherein the lower portion of the pallet foot comprises two through grooves.

31. The pallet foot according to claim 20, wherein the height (H) of the pallet foot is between 50-150 mm, and the width of the pallet foot is between 90-160 mm.

32. The pallet foot according to claim 20, wherein the height of the pallet foot is between 75-110 mm, and the width of the pallet foot is between 110-140 mm.

33. The pallet foot according to claim 20, wherein the height of the pallet foot is between 80-100 mm, and the width of the pallet foot is between 120-130 mm.

34. The pallet foot according to claim 20, wherein each of said attachment members comprises an uppermost pointy portion for facilitating penetration of a platform, and at least one retaining element arranged to permanently retain said pallet foot on the platform once the pallet foot is attached thereto.

35. The pallet foot according to claim 20, wherein said plurality of attachment members comprises at least two counteracting retaining elements arranged to cooperate with each other for locking the attachment members against the surface of the platform to be penetrated.

36. The pallet foot according to claim 20, wherein said attachment member preferably has a height between 5-15 mm, and a width between 4-12 mm.

37. The pallet foot according to claim 20, wherein said attachment member preferably has a height between 7-10 mm, and a width between 5-7 mm.

38. A pallet comprising a flat penetrable sheet and at least three pallet feet penetrating said sheet, wherein said pallet feet are arranged to be attached onto a penetrable sheet, and wherein each pallet foot has an overall hollow shape and comprises an upper base portion having a stopping surface arranged to meet the surface of said sheet, said upper base portion further comprising a plurality of attachment members, wherein said plurality of attachment members are arranged to pierce through the undersurface of said sheet, and that said plurality of attachment members further are arranged to at least partially penetrate the thickness (t) of said sheet and to permanently retain said pallet foot on the sheet once the pallet foot is attached thereto.

39. A box comprising a flat penetrable bottom and at least three pallet feet penetrating said bottom, wherein each pallet foot has an overall hollow shape and comprises an upper base portion having a stopping surface arranged to meet the surface of said bottom, said upper base portion further comprising a plurality of attachment members, wherein said plurality of attachment members are arranged to pierce through the undersurface of said bottom, and that said plurality of attachment members further are arranged to at least partially penetrate the thickness (t) of said bottom and to permanently retain said pallet foot on the bottom once the pallet foot is attached thereto.

40. A method for attaching a pallet foot to a backside of a platform comprising:
a) providing a platform having an underside and an upper side;
b) providing a pallet foot where the pallet foot has an overall hollow shape and comprises an upper base portion having a stopping surface arranged to meet the surface of said platform, said upper base portion further comprising a plurality of attachment members, wherein said plurality of attachment members are arranged to pierce through the undersurface of said platform, and that said plurality of attachment members further are arranged to at least partially penetrate the thickness of said platform and to permanently retain said pallet foot on the platform once the pallet foot is attached thereto;
c) positioning the pallet foot in such a way that the base portion comprises a stopping surface and a plurality of attachment members are facing the underside of said platform in a position corresponding to the desired position for attaching the pallet foot; and
d) forcing said attachment members to pierce through the platform surface to at least partly penetrate the thickness of said platform until the stopping surface meets the platform surface, thereby permanently attaching the pallet foot onto the underside of said platform.

41. The method according to claim 40, wherein in step (d) said attachment members are forced to penetrate the platform by pressing or hitting the pallet foot against the underside of the platform.

42. The method according to claim 40, wherein, in step (d), the attachment members are forced to completely penetrate through the entire thickness (t) of said platform so that at least a portion of the attachment members are protruding from the upper side of the platform.

43. The method according to claim 40, wherein the method further comprises providing the platform as a sheet of paper based material or the bottom of a paper box.
